(19) United States
(12) Patent Application Publication
(10) Pub. No.: US 2005/0021610 A1
(43) Pub. Date: Jan. 27, 2005

(54) Method and arrangement for accessing a first terminal in a first communication network from a second communication node in a second communication network

(76) Inventors: Bruno Bozionek, Borchen (DE); Dieter Hemkemeyer, Olde (DE); Rainer Zimmermann, Paderborn (DE)

Correspondence Address: SIEMENS CORPORATION;INTELLECTUAL PROPERTY DEPT., 170 WOOD AVENUE, SOUTH, ISELIN, NJ, 08830, US

(21) Appl. No.: 10/875,852

(22) Filed: Jun. 24, 2004

(30) Foreign Application Priority Data
Jun. 27, 2003 (DE) 10329084.2

(51) Int. Cl. G06F 15/16

(52) U.S. Cl. 709/203

(57) ABSTRACT

Method and arrangement for accessing a first terminal in a first communication network from a second communication node in a second communication network.

To access a first terminal (EG1) in a first communication network (N1) from a second communication node (K2) in a second communication network (N2), the first and second communication networks (N1 and N2) are connected to one another for the purpose of interchanging control data using a proxy server (PRX). The first terminal (EG1) is registered with the second communication node (N2) by the proxy server (PRX) like a terminal at the second communication node (K2), which means that the second communication node (K2) manages the first terminal (EG1) as a terminal at the second communication node (K2). The first terminal (EG1) is then represented by the proxy server (PRX) in the second communication network (N2) by virtue of the proxy server (PRX) being respectively used to transfer the control data relating to the first terminal between the first communication node (K1) and the second communication node (K2).

### CROSS REFERENCE TO RELATED APPLICATIONS

This application claims priority to the German application No. 10329084.2, filed Jun. 27, 2003 and which is incorporated by reference herein in its entirety.

### FIELD OF INVENTION

The invention relates to a method for accessing a first terminal in a first communication network from a second communication node in a second communication network, and to an arrangement for carrying out the method.

### BACKGROUND OF INVENTION

To operate terminals, particularly voice terminals, fax machines and similar communication terminals, communication networks having different topologies and various technical designs are operated. Thus, by way of example, a distinction is drawn between circuit switched communication networks, which include the known ISDN network and many other public communication networks, and packet switched networks, in which the user information is transmitted in the form of data packets, for example in line with the Internet protocol (IP protocol). The latter are also referred to as voice data networks or VoIP networks (VoIP=Voice-over-Internet protocol).

Both the circuit switched communication networks group and the packet switched communication networks group include various types of networks which differ from one another technically in that the respective components of these networks cannot readily be connected to one another. Thus, by way of example, circuit switched communication networks include analog and digital communication networks which can interchange information with one another only with the aid of interposed components, frequently also referred to as gateways. In this case, the gateways perform both media conversion (between different transmission paths) and signaling conversion (between different communication protocols); in the text below, however, the term “gateway” is also used for devices which perform exclusively signaling conversion. In the case of packet switched communication networks too, a distinction is drawn between various embodiments which either cannot communicate with one another at all or can communicate only to a restricted extent if there is no device for signaling conversion (also called a “border element” or “signaling interworking unit”; in this case too, “gateway”) connected between these networks. In the case of the packet switched communication networks, the most frequent reason for this functional restriction is that the various communication networks may also use various communication protocols. Even if the same transfer protocol—usually the known Internet protocol—is used for transferring the data packets, these networks are frequently not compatible with one another if the control data and/or the user information are designed on the basis of different communication protocols. Examples of such communication protocols which are not completely compatible, at least in terms of the control data, are the ITU-T-H.323 protocol and the IETF-SIP (SIP=Session Initiation Protocol). If a voice data network operates both communication components which communicate with one another on the basis of the H.323 protocol and such components that use the SIP protocol, then, despite the jointly used network infrastructure in this arrangement, two (logically separate) communication networks are being considered.

In the text below, the term “control data” denotes both signaling information for controlling a connection or an appliance and state information which describes the operating state of a terminal (e.g. “free”, “engaged”, “online”, “offline”) or of another network component (e.g. “operational”, “fault”, “idle”, “full capacity”).

In the case of the components in the communication networks, a distinction is drawn between the communication nodes and the terminals, with the term “terminal” not being limited to the telephone usually used hitherto, but rather denoting, in a very general form, the source or destination of user information in communication networks. While the communication nodes in the circuit switched communication networks have the basic function of interconnecting transmission lines or user data channels (B channels) between terminals or between terminals and exchange lines or tie lines as their task, the function of the communication nodes in packet switched communication networks is essentially connection control and the provision of necessary control information, for example in the form of network addresses. Communication nodes in packet switched communication networks are usually not directly involved in transferring the user data, however; when the logical connection has been set up, these are transferred directly between the terminals (“end-to-end” or “peer-to-peer”).

A general basic requirement for operating communication networks is the option of being able to interchange user information with other communication networks. To this end, the known circuit switched communication networks use the aforementioned exchange lines or tie lines, with a gateway needing to be provided in cases in which communication networks of different types are connected. In circuit switched communication networks, this gateway often comprises a “media converter”, which is frequently already implemented at the communication nodes themselves. Gateways are likewise known for interchanging user information, for example for voice connections, between circuit switched communication nodes and communication nodes in packet switched communication networks. In this case, a number of exchange lines or tie lines is connected from the circuit switched communication node to the gateway, while the gateway at the other end is in contact with the communication node in the packet switched communication network. If the gateway is controlled by this latter communication node, then this communication node is also referred to as a gatekeeper. In this case, such a gatekeeper is simultaneously used also for converting telephone numbers, as are used in circuit switched communication networks, into the network addresses which are normally used in the packet switched communication networks for addressing purposes or for data interchange between the terminals used therein (frequently also referred to as clients).

The communication nodes in packet switched communication networks operate using the “registration” principle. This means that any device in this communication network, that is to say any terminal or any gateway, which is intended to interchange data with this communication node needs to have been registered with this communication node. This is required because the packet switched communication networks frequently make use of a data network which may contain a multiplicity of other network components which are not part of this communication network. In this case, terminals have been registered in a different way than occurs with the gateways.

Besides the basic functionality which comprises setting up and operating communication connections, modern communication networks provide services going beyond this. By way of example, the aforementioned SIP protocol makes it possible for a terminal which is equipped with a display to display the operating state of a number of or all other terminals in the same communication network on a permanent basis. This service is also called a “presence service”. For this service to work, it is naturally necessary for the communication node which provides this service to receive information about the operating state (status) of the respective displayed terminal on a permanent basis, the terminal being monitored normally itself transmitting this information to the service whenever its operating state changes. Another service defined in the SIP protocol is “instant messaging”, which provides a simple way of sending messages (e.g. text messages or audio signals) between the terminals in a communication network. In this case, a text message is transmitted from the sending terminal to the communication node and is then forwarded to the receiving terminal from this communication node. A drawback which has been found in this case is that although the two services described and a whole series of other services and applications work within one and the same communication network, they cannot be used across networks. By way of example, it is not possible for the “presence list” on a terminal in a first communication network to display the state information for a terminal in another communication network on a permanent basis, even if the two communication networks are connected to one another by means of a gateway. The reason for this is that the necessary state information is not interchanged between the communication nodes via the gateway.

### SUMMARY OF INVENTION

It is an object of the invention to propose a method which can be used to operate services in a communication network even with terminals in another communication network, and an arrangement for carrying out the method.

The object is achieved by the claims.

The solution for the method provides for the first and second communication nodes to be connected to one another via a proxy server. In this case, the first terminal is registered with the second communication node like a terminal at the second communication node, which means that the second communication node manages the first terminal as a terminal at the second communication node. The proxy server represents the first terminal in the second communication network by virtue of the proxy server being respectively used to transfer the control data relating to the first terminal between the first communication node and the second communication node. This allows the second communication node to access the terminal as if the terminal were a terminal registered with the second communication node. The second communication network therefore registers terminals from the first communication network, which means that they can be accessed and managed by the applications in the second communication network. The proxy server is thus the “representative” of the first terminal in the second communication network.

The solution for the arrangement provides for a proxy server to be used for accessing the first terminal, said proxy server having a registration device for registering the first terminal with the second communication node as a terminal in the second communication network, and having a conversion device which is designed for converting those control data relating to the first terminal which are sent by the second communication node into the data format based on the first communication protocol, and for converting those control data relating to the first terminal which are sent by the first communication node into the data format based on the second communication protocol. The use of this proxy server means that, for the second communication node, the terminal at the first communication node is represented as a terminal in the second communication network. In addition, the proxy server can also represent a plurality of terminals in the first communication network or else terminals and devices from other communication networks in the second communication network. In this case, the proxy server is not necessarily a stand-alone appliance, but rather may equally be installed as a software component together with other software components on a common piece of computer hardware.

The method and the arrangement are advantageously refined by the features of the dependent patent claims. In this case, the advantages described for the method also apply in the appropriate sense to the arrangement.

If the first communication network uses a first communication protocol for the data format of the control data used in the first communication network, if the second communication network uses a second communication protocol for the data format of the control data used in the second communication network, and if the proxy server converts the control data which it transfers from the first communication node to the second communication node from the data format based on the first communication protocol into the data format of the second communication protocol, and vice versa, then the proxy server can be used to connect communication networks using different communication protocols to one another. In this case, from the point of view of the second communication node, the result is a uniform communication network using just one communication protocol, with the terminals in the first communication network being able to be treated by the second communication node like the terminals in the second communication network. From the point of view of the second communication node, this results in the “one system image”.

The first terminal may advantageously be incorporated into the communication structure of the second communication network if the second communication node provides at least one service in the second communication network, said service processing state information relating to the first terminal. In this case, the service requests the state information from the proxy server in the form of a request message based on the data format of the second communication protocol. The proxy server converts the request message into the data format of the first communication protocol and transfers it to the first communication node, after which the first communication node transfers the state information in the data format of the first communication protocol to the proxy server as a response, and the proxy server converts this state information into the data format of the second communication protocol. Next, the converted state information is transferred from the proxy server to the second communication node, whereupon the state information is processed by the service at the second communication node.

Besides the first communication node, there may also be other communication nodes available which likewise hold state information about the first terminal or about the user associated with the first terminal. This state information may also be used in the second communication network, separately or together with the state information which is available at the first communication node, by virtue of the second communication node providing at least one service in the second communication network, said service processing state information which relates to the first terminal and/or to a user associated with the first terminal (EG1). To this end, the service uses control data in the form of a request message based on the data format of the second communication protocol to request the state information from the proxy server. In this case, the proxy server is connected up to a third communication node, which interchanges control data in line with a third communication protocol, the third communication node storing state information about the first terminal. The proxy server then converts the request message into the data format of the third communication protocol, and for the third communication node the state information in the data format of the third communication protocol is transferred to the proxy server as a response, the state information is converted into the data format of the second communication protocol by the proxy server and is transferred to the second communication node, after which it is processed by the service at the second communication node.

If the second communication network used is a packet switched communication network in which the SIP protocol is used as the communication protocol, and if the second communication node used is an SIP proxy server, then the applications and services defined for SIP communication networks may be used together with the terminals in other communication networks using other communication protocols.

The administration of the second communication node is simplified by virtue of the first terminal being registered with the second communication node by the proxy server.

Resources can be saved by virtue of the proxy server representing a plurality of terminals in the second communication network.

If the first communication network and the second communication network are two voice data networks in which the user information is interchanged directly between the terminals, then it is possible to dispense with the use of a separate gateway if, when a communication connection is set up between the first terminal and a terminal in the second communication network, the proxy server transfers the respective control data between the first and second communication nodes.

Exemplary embodiments of the inventive method are explained below with reference to the drawings and are simultaneously used to explain an exemplary embodiment of the inventive arrangement.

### BRIEF DESCRIPTION OF THE DRAWINGS

In the drawings,

FIG. 1 shows an arrangement comprising two communication networks which are connected to one another via a proxy server, and

FIG. 2 shows the time sequence of the protocol messages which are interchanged via a proxy server in order to set up a call connection between a terminal in a circuit switched network and a terminal in a packet switched network.

### DETAILED DESCRIPTION OF INVENTION

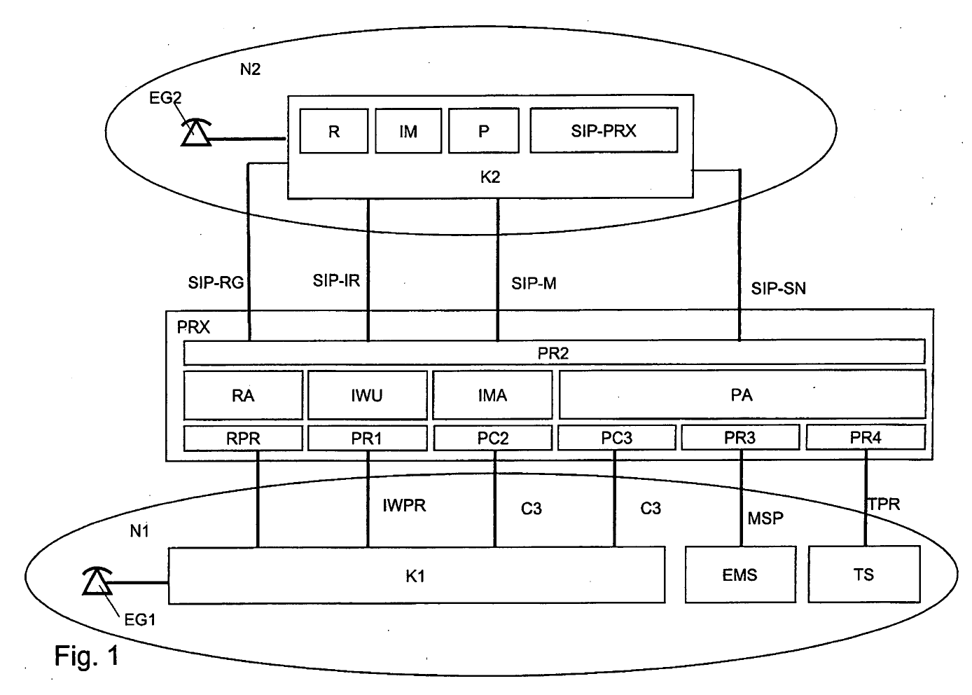

FIG. 1 shows two communication networks N1, N2 which are connected to one another via a proxy server PRX. In the communication network N1, the first communication node shown is the communication installation K1, the e-mail server EMS and, as the central component of an operating time recording system, the time server TS. It goes without saying that the time server TS and the e-mail server EMS also have terminals and other devices connected to them, which are not shown for reasons of clarity, however. The communication installation K1 has the terminal EG1 connected to it. The second communication node arranged in the communication network N2 is the SIP server K2, with which the terminal EG2 has been registered. The SIP server comprises, as a component (entity) installed in the form of software, the SIP proxy server SIP-PRX, which is used for interchanging signaling messages in the communication network N2 and hence performs functions comparable to those of the gatekeepers in H.323 communication networks.

The proxy server PRX is equipped with a piece of software which is of modular design and is split into various units. Among these units, a distinction is drawn between units for protocol conversion (“protocol stacks”) and units for providing a service (“function modules”). The units for protocol conversion respectively have a connection to an interface between communication nodes and servers. These connections, which are either in the form of a data line or in the form of a channel in a data network, are shown in FIG. 1 in the form of lines which have been provided with abbreviations for the communication protocol associated with the respective connection.

The connections shown in FIG. 1 between the units for protocol conversion for the proxy server PRX and the communication nodes K1, K2, EMS, TS are used for transferring control and state information. Other (user) information, for example the voice information (voice data) which is interchanged between the terminals EG1 and EG2 in the course of a call connection, is interchanged directly between the terminals EG1 and EG2 on a separate logical connection (not shown here).

The communication network N2 is a packet switched communication network using the communication protocol SIP (Session Initiation Protocol); the SIP protocol is a communication protocol which has been standardized by the IETF (Internet Engineering Task Force) and which supports not only the communication connections (telephone calls, fax connections or the like) as such but also further services such as “instant messaging” and “presence application”. In this case, the functions of the SIP protocol need to be divided into functional groups; a subprotocol family can then be denoted by SIP-RG and is used for registering terminals, SIP-IR is responsible for controlling communication connections, SIP-M is responsible for interchanging messages, and SIP-SN is responsible for the concerns of the “presence” service. These services are considered in more detail below.

The components of the communication network N1, particularly the communication installation K1, the e-mail server EMS and the time server TS, are also connected to one another and to the proxy server PRX via a data network. Alternatively, the e-mail server EMS and the time server TS may also be arranged in a different communication network; what is important is that they are connected to the proxy server PRX. The communication installation K1 is in a form such that it serves as a communication node both for terminals which communicate using packet switching and for terminals which are connected using circuit switching; in this case, the terminal EG1 is a terminal which is connected using circuit switching, that is to say a “conventional” terminal. The communication installation K1 comprises a gateway (not shown here) which supports communication connections between circuit switched terminals and packet switched terminals. In principle, the exemplary embodiment is also valid for a terminal which is connected using packet switching, in which case the gateway integrated in the communication installation K1 is not used.

In the communication network N1—unlike in the communication network N2—the communication protocol used for the packet switched voice data communication (VoIP) is the ITU-T-H.323 protocol (H.323 for short). While the H.323 protocol differs significantly from the SIP protocol used in the communication network N2 in terms of the control data (signaling information, state information), these two communication protocols are compatible with one another in terms of the voice data transferred, which in both cases are transferred on the basis of the RTP/RTCP (Real Time Protocol/Real Time Control Protocol). The proxy server PRX is thus used firstly for converting the control data into the communication protocol used in the respective communication network and secondly for the use of additional applications (service features) used in the form of services in the communication network N2, but not for converting the voice data. The proxy server (PRX) is thus a conversion device for the communication protocols used in the first communication network and in the second communication network (N2).

The devices (processing units) provided in the proxy server PRX for the purpose of using services in the communication network N2 are also referred to as “agents”. These agents present themselves to the SIP server K2 as the corresponding devices for a (further) terminal in the communication network N2. A registration agent RA is thus used as a processing unit for the proxy server PRX for the purpose of registering a terminal with the SIP server K2. It goes without saying that the terminal EG2 is also equipped with a separate registration function (not shown here) for registering it with the SIP server K2.

Another processing unit for the proxy server PRX is a protocol converter IWU (Interworking Unit), which converts the control and signaling information from the communication protocol H.323 used in the communication network N1 into the signaling based on the SIP protocol of the communication network N2 for communication connections (calls, faxes etc.). To this end, the protocol converter IWU makes use of a protocol stack PR1 in the communication network N1 for the purpose of data interchange based on the H.323 protocol and makes use of a protocol stack PR2 in the communication network N2 (SIP/SDP/SIMPLE protocol unit).

The communication network N2 has a service available which is used for interchanging messages immediately and is known as “instant messaging”. To this end, the terminal EG2 contains a corresponding application which shows the user interface for using this service, and the SIP server K2 contains the corresponding server application IM (Instant Messaging server application) for receiving, buffer-storing and sending messages. For the purpose of communicating with this server application IM in the SIP server K2, the proxy server PRX contains the Messaging Agent processing unit (function module) IMA, which makes use of a protocol stack PR2 in the communication network N2 and makes use of a protocol stack PC2 in the communication network N1. The protocol stack PC2 communicates with the communication installation K1 using the communication protocol C3, for which purpose a form (“CSTA Phase III”) of the CSTA protocol (CSTA=Computer Supported Telephony Application) is used in this exemplary embodiment. The CSTA protocol defines elements for accessing circuit switched communication installations, which also cover the transfer of character strings which can be displayed on displays on telephony terminals.

Another application for the “messaging” service is the display of unread (new) e-mails which are available for the user of the terminal EG1 on the e-mail server EMS. To this end, the messaging agent IMA polls the e-mail server EMS at regular intervals of time and displays new messages on the display of a terminal (in this case the terminal EG2) using the server application IM.

Another, often used application (these are also referred to as “services”) in communication networks based on the SIP protocol is the “presence service” This is a list of subscribers and the respective availability states of these subscribers (unobtainable, in a meeting, away on business, . . . ) which is displayed on the display of an SIP-compliant terminal (which may also be a multimedia PC). This list may be compiled individually by the user of the terminal in question, and it then displays the user's most important communication partners, for example. A particular feature of this subscriber list is that it involves state information about the subscribers in question being displayed permanently on the terminal's display, for example whether the subscriber in question is free, engaged, active (obtainable) or passive (“offline”). This information is buffer-stored for all “observed” subscribers (terminals) on the presence server P associated with the SIP server K2 and is forwarded to the respective presence application on the terminals, in this case the terminal EG2. In order to represent the terminal EG1 in the communication network N2, the proxy server PRX comprises a processing unit, the presence agent PA, which is associated with this service. While the presence agent PA uses the protocol stack PR2 to provide the SIP server K2 with state information about the terminal EG1, it uses the protocol stacks PC3, PR3 and PR4 to obtain this state information. To this end, the presence agent PA uses the protocol stack PC3 to access the communication installation K1, using the communication protocol C3 (CSTA Phase III protocol), in order to request the state of the terminal EG1 (that is to say “active” or “passive”). In addition, the presence agent PA uses the protocol unit PR3 to access the e-mail server EMS, using the communication protocol MSP (“Mail Server Protocol”). The user of the terminal EG1 is able to keep an e-mail mailbox on the e-mail server EMS and to set in this mailbox whether he is absent, which then results in a corresponding absence notice for incoming e-mail messages. This setting is requested and evaluated by the presence agent PA and is used to establish or generate state information about the terminal EG1.

The presence agent PA can also use other data sources in order to determine the operating state of the terminal EG1, FIG. 1 showing the time server TS by way of example. The time server TS is used to store data which—for example in a company—are stored by the access control (chip card readers on doors, or the like). It is thus a database revealing whether or not a person is present in a building. The protocol unit PR4 is used by the presence application to access this database using an access protocol TPR (Time Server Protocol), in order to transmit the presence information stored in the time server TS to the presence server P in the SIP proxy server K2 and hence ultimately to the presence application in the terminal EG2.

The registration agent RA in the proxy server PRX is used as a registration device for registering the terminal EG1 with the SIP server K2. In the case shown in FIG. 1, the communication installation K1 performs the registration when the terminal EG1 is connected, by sending an appropriate message to the protocol stack RPR (Registration Protocol Unit) in the proxy server PRX. This message is forwarded to the registration agent RA, where it is processed and converted into a new registration message which is sent via the protocol stack PR2 to the registration server R arranged in the SIP server K2.

Alternatively, however, registration may also be effected from an external entity (not shown here), for example an administrator workstation. In that case, the protocol unit RPR is used to access the registration agent RA from such an administrator workstation.

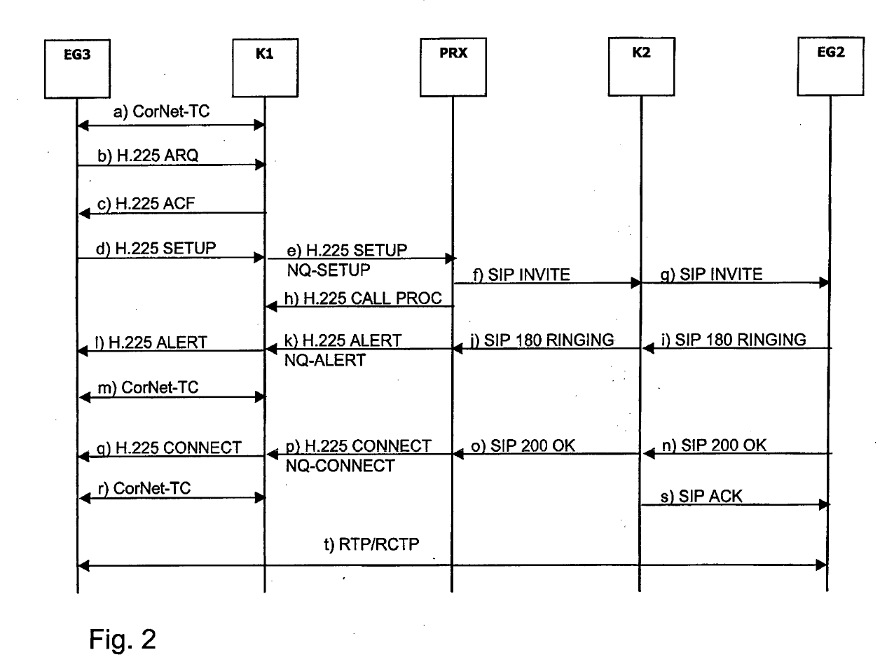

FIG. 2 shows the timing for setup of a communication connection between the terminal EG1 and the terminal EG2. To set up the communication connection, control data (signaling information) in the form of control messages are interchanged between the terminal EG1, the communication installation K1, the proxy server PRX, the SIP server K2 and the terminal EG2. The control data transferred in the process are shown by arrows, with the arrow direction illustrating the direction of transfer for the control message transmitted in the respective method step. Each arrow in this scheme has been provided with a short descriptor, to which reference is respectively made below and which is an abbreviation for the communication protocol used in the respective method step. In this context, the illustration is to be read from top to bottom, i.e. the control message or group of control messages denoted by the label “a) CorNet-TC” has been interchanged at the start of connection setup, and the established user data connection shown by the label “t) RTP/RCTP” and by a double arrow is at the end of connection setup.

The components denoted by the abbreviations K1, PRX, K2, EG2 are identical to the components from FIG. 1 which have the same designations. Unlike the terminal EG1 introduced as part of the description of figures which relates to FIG. 1, a terminal EG3 which is connected to the communication installation K1 is a “VoIP terminal”, that is to say a voice data terminal which communicates using packet switching. In principle, the terminal EG3 communicates on the basis of the known communication protocol H.323, the H.323 protocol being a “protocol family” comprising various subordinate protocols. In addition, the communication network N1 uses the G.711 standard, which describes the compression of voice data, and the H.225 standard (described in more detail below), which describes the signaling in voice data networks based on the H.323 protocol. Since the H.323 standard does not support all of the service features required in modern communication networks even though—as already mentioned above in the introduction to the SIP protocol—it is in widespread use, a modified, extended communication protocol is used for signaling between the terminal EG3 and the communication installation K1, said communication protocol being company-specific and bearing the name CorNet-TC. This is necessary for this exemplary embodiment in particular, because not only VoIP terminals communicating using packet switching but also circuit switched terminals (such as the terminal EG1 from FIG. 1) are connected to the communication installation K1, these being actuated using the proprietary communication protocol CorNet-TS developed for circuit switched communication networks. This CorNet-TS protocol supports a broad scope of service features and is therefore used as CorNet-TC protocol in the form modified for packet switched networks.

In a first step, the terminal EG3 registers with the communication installation K1. For this registration operation, which is shown by an arrow with the reference symbol a), the communication protocol CorNet-TC described above is used. In step b), the terminal EG3 registers a connection request with the communication installation K1, said connection request being reported by the message “ARQ” in line with the H.225 protocol. In step c), the communication installation K1 responds with the message “ACF” in line with the same communication protocol. The terminal EG3 now reports the specific call request, which also comprises the telephone number of the called terminal EG2, to the communication installation K1 in step d) using the message “Setup”. The communication installation K1 forwards this request to the proxy server PRX in step e). The proxy server PRX firstly confirms the received command to the communication installation K1 in step h), and secondly uses the message “Invite” to report to the SIP server K2 the call request from terminal EG3 to terminal EG2 in line with the SIP protocol in step f). In step g), the SIP server K2 forwards this call request to the terminal EG2, which then signals the call. The confirmation that the call is currently being signaled is sent to the SIP server K2 by the terminal EG2 in step i) using the message “Ringing”, and is sent to the proxy server PRX by the SIP server K2 in step j) using the same message. The proxy server PRX converts the message “Ringing” into the H.225 protocol and hence also into the CorNet-NQ protocol (a proprietary extended communication protocol for tie lines) in step k) and transmits it to the communication installation K1 in the form of the “Alert” or “NQ-Alert” message. In step 1), the communication installation K1 forwards this message to the terminal EG3.

In step n), the information that the terminal EG3 is now ready to set up the user data connection is interchanged between the terminal EG3 and the communication installation K1 in a message based on the CorNet-TC protocol. A wait state now arises which lasts until the user of the terminal EG2 takes the call. In this case, the terminal EG2 uses the message “OK” to the SIP server K2 in step n), and the SIP server K2 in turn forwards this message “OK” to the proxy server PRX in step o). This message coded on the basis of the SIP protocol is now converted into the message “Connect” in the proxy server PRX and is transmitted to the communication installation K1 in step p). In this case, although the message “Connect” is part of the CorNet-NQ tie line protocol, it is simultaneously defined in the H.225 protocol as well. In step q), this confirmation is finally forwarded to the terminal EG3. Upon receiving the message “OK” in step n), the SIP server K2 sent a confirmation message to the terminal EG2, and receipt of this message now prompts the terminal EG2 to adopt transmission and reception mode for the user data channels. Equally, the terminal EG3 likewise starts the transmission and reception mode on the appropriate user data channels in step q) when it receives the “Connect message”, the parameters of said user data channels having been negotiated using the protocol-based messages described above. When the transmission and reception mode is adopted, the terminal EG3 sends a corresponding status message to the communication installation K1 in step r), so as to document the call state which has now changed. When the transmission and reception mode is adopted in step t), a user data connection based on the RTP/RCTP protocol now exists between the terminals EG3 and EG2.

1-11. (cancelled)

12. A method for accessing a first terminal at a first communication node in a first communication network from a second communication node in a second communication network, comprising:
registering the first terminal with the first communication node;
connecting the first and second communication network for interchanging control data and user data;
connecting the first and second communication node via a proxy server; and
registering the first terminal with the second communication node like a terminal at the second communication node, wherein
the second communication node manages the first terminal as a terminal at the second communication node, wherein
the proxy server represents the first terminal in the second communication network by virtue of the proxy server being respectively used to transfer the control data relating to the first terminal between the first communication node and the second communication node.

13. The method as claimed in claim 12, wherein
the first communication network uses a first communication protocol for the data format of the control data used in the first communication network, wherein
the second communication network uses a second communication protocol for the data format of the control data used in the second communication network, and wherein
the proxy server converts the control data which it transfers from the first communication node to the second communication node from the data format based on the first communication protocol into the data format of the second communication protocol, and vice versa.

14. The method as claimed in claim 13, wherein
the second communication node provides a service in the second communication network, wherein
the service processes state information describing the operating state of the first terminal, wherein
the service uses control data in the form of a request message based on the data format of the second communication protocol to request the state information from the proxy server, wherein
the proxy server converts the request message into the data format of the first communication protocol and transfers it to the first communication node, wherein
the first communication node transfers the state information in the data format of the first communication protocol to the proxy server as a response, wherein
the proxy server converts the state information into the data format of the second communication protocol and transfers it to the second communication node, and wherein
the service processes the state information at the second communication node.

15. The method as claimed in patent claim 13, wherein
the second communication node provides at least one service in the second communication network, wherein
the service processes state information relating to the first terminal, wherein
the service uses control data in the form of a request message based on the data format of the second communication protocol to request the state information from the proxy server, wherein
the proxy server is connected up to a third communication node, which interchanges control data in line with a third communication protocol, wherein
the third communication node stores state information about the first terminal and/or about a user associated with the first terminal, wherein
the proxy server converts the request message into the data format of the third communication protocol and transfers it to the third communication node, wherein
the third communication node transfers the state information in the data format of the third communication protocol to the proxy server as a response, wherein
the proxy server converts the state information into the data format of the second communication protocol and transfers it to the second communication node, and wherein
the service processes the state information at the second communication node.

16. The method as claimed in patent claim 12, wherein
the second communication network is a packet switched communication network, wherein
the second communication network uses the SIP protocol as the communication protocol, and wherein
the second communication node used is an SIP proxy server.

17. The method as claimed in patent claim 13, wherein
the second communication network is a packet switched communication network, wherein
the second communication network uses the SIP protocol as the communication protocol, and wherein
the second communication node used is an SIP proxy server.

18. The method as claimed in patent claim 14, wherein
the second communication network is a packet switched communication network, wherein
the second communication network uses the SEP protocol as the communication protocol, and wherein
the second communication node used is an SIP proxy server.

19. The method as claimed in patent claim 12, wherein the first terminal is registered with the second communication node by the proxy server.

20. The method as claimed in patent claim 13, wherein the first terminal is registered with the second communication node by the proxy server.

21. The method as claimed in patent claim 12, wherein the proxy server represents a plurality of terminals in the second communication network.

22. The method as claimed in patent claim 13, wherein the proxy server represents a plurality of terminals in the second communication network.

23. The method as claimed in patent claim 12, wherein, when a communication connection is set up between the first terminal and a terminal in the second communication network, the proxy server transfers between the first and second communication nodes the respective control data required for setting up the communication connection.

24. The method as claimed in patent claim 13, wherein, when a communication connection is set up between the first terminal and a terminal in the second communication network, the proxy server transfers between the first and second communication nodes the respective control data required for setting up the communication connection.

25. A method for accessing a first terminal at a first communication node in a first communication network from a second communication node in a second communication network, wherein
the first terminal is registered with the first communication node, wherein
the first and second communication networks are connected to one another for the purpose of interchanging control data and user data, wherein
the first and second communication nodes are connected up to one another using a proxy server, wherein
the first terminal is registered with the second communication node, wherein
the second communication node manages the first terminal as a terminal at the second communication node, wherein
the proxy server represents the first terminal in the second communication network, and
transferring the control data relating to the first terminal between the first communication node
and the second communication node via the proxy server.

26. An arrangement for accessing a first terminal in a first communication network from a second communication node in a second communication network, the arrangement comprising:
a first communication node provided by the first communication network, wherein
the first terminal has been registered with the first communication node and a second terminal has been registered with the second communication node, wherein
the first terminal is adapted for registration with the first communication node, wherein
the first communication network is adapted for transferring control data in a data format based on a first communication protocol and the second communication network is adapted for transferring control data in a data format based on a second communication protocol, and wherein
the first and second communication networks are connected to one another for the purpose of interchanging control data and user data; and
a proxy server adapted to access the first terminal, wherein
the proxy server having a registration device for registering the first terminal with the second communication node as a terminal in the second communication network, wherein
the proxy server having a conversion device adapted for converting those control data relating to the first terminal which are sent by the second communication node into the data format based on the first communication protocol, and being adapted to convert those control data relating to the first terminal which are sent by the first communication node into the data format based on the second communication protocol.

27. The arrangement as claimed in patent claim 26, wherein
the second communication network comprises an application for providing a service which processes state information about the first terminal, wherein
the application is adapted for requesting the state information from the proxy server, and wherein
the proxy server comprises a processing unit adapted for requesting the state information from the first communication node and for forwarding the state information to the application.

28. The arrangement as claimed in patent claim 26, wherein
the second communication network comprises an application for providing a service which processes messages associated with the first terminal, and wherein
the proxy server comprises a processing unit adapted for requesting the associated messages from a communication node and for forwarding the associated messages to the further application.
